(19) United States
(12) Patent Application Publication
(10) Pub. No.: US 2012/0312975 A1
(43) Pub. Date: Dec. 13, 2012

(54) ELECTRON BEAM EXPOSURE APPARATUS AND ELECTRON BEAM EXPOSURE METHOD

(76) Inventors: Katsuhiko Kobayashi, Tokyo (JP); Tatsuro Okawa, Tokyo (JP)

(21) Appl. No.: 13/482,599

(22) Filed: May 29, 2012

(30) Foreign Application Priority Data
Jun. 7, 2011 (JP) 2011-127213

(51) Int. Cl. H01J 3/26

(52) U.S. Cl. 250/252.1; 250/400

(57) ABSTRACT

Main deflection regions are arranged assuming that the positions of column cells are as designed, and adjacent main deflection regions are joined together to form a joined main deflection region. Then, a corrected main deflection region is arranged by correcting the position of each of the main deflection regions based on the actual positions of the column cells. After that, whether or not each of auxiliary deflection regions contained in the joined main deflection region overlaps with the corrected main deflection region is checked in predetermined order. Then, the auxiliary deflection regions overlapping with the corrected main deflection region are arranged in the order of detection thereby to yield auxiliary deflection region data.

### CROSS-REFERENCE TO RELATED APPLICATION

This application is based upon and claims the benefit of priority of the prior Japanese Patent Application No. 2011-127213, filed on Jun. 7, 2011, the entire contents of which are incorporated herein by reference.

### FIELD

The embodiments discussed herein are related to an electron beam exposure apparatus and an electron beam exposure method, and more particularly. to a multi-column type electron beam exposure apparatus and an electron beam exposure method for performing exposure processes in parallel by plural column cells.

### BACKGROUND

In recent years, electron beam exposure apparatuses capable of fine patterning with accuracy without using a mask have been used for patterning on a semiconductor wafer. One of .such electron beam exposure apparatuses is a multi-column type electron beam exposure apparatus provided with plural column cells for electron beam irradiation to perform exposures in parallel, thus achieving a higher speed of patterning.

The multi-column type electron beam exposure apparatus includes a controller storing a scheduling software program to produce data (i.e., individual exposure data) for control of each of the column cells. The scheduling software program causes the controller to produce whole-wafer exposure data based on design data and divide the exposure data into units of regions assigned to the column cells. Then, the divided exposure data is reedited to form individual exposure data according to the actual positions of the column cells.

However, the conventional electron beam exposure apparatus has a problem of being incapable of quick exposure because it takes time to reedit exposure data.

Patent Literature 1: Japanese Laid-open Patent Publication No. 2002-305141

### SUMMARY

According to one aspect of the invention, there is provided an electron beam exposure apparatus including: a stage configured to moves a sample to and fro in a certain direction; plural column cells each configured to irradiate the sample with an electron beam; a main deflector provided in each of the column cells, and configured to deflect the electron beam and thereby control the position of irradiation with the electron beam in a main deflection region; an auxiliary deflector provided in each of the column cells, and configured to deflect the electron beam and thereby control the position of irradiation with the electron beam in an auxiliary deflection region smaller than the main deflection region; and a scheduler configured to generate auxiliary deflection region data defining an order in which the auxiliary deflection regions contained in the main deflection region are to be irradiated with the electron beam, the scheduler including a static unit configured to create a joined main deflection region by joining each of the main deflection regions to an adjacent main deflection region which are arranged assuming that the positions of the column cells are as designed, and a dynamic unit configured to obtain a corrected main deflection region by correcting the position of each of the main deflection regions based on the actual positions of the column cells, and to generate the auxiliary deflection region data by collecting data for the auxiliary deflection regions contained in an overlapping portion of the corrected main deflection region and the joined main deflection region.

Also, according to another aspect of the invention, there is provided an electron beam exposure method using an electron beam exposure apparatus including: a stage configured to move a sample to and fro in a certain direction; plural column cells each configured to irradiate the sample with an electron beam; a main deflector provided in each of the column cells, and configured to deflect the electron beam and thereby control the position of irradiation with the electron beam in a main deflection region; an auxiliary deflector provided in each of the column cells, and configured to deflect the electron beam and thereby control the position of irradiation with the electron beam in an auxiliary deflection region smaller than the main deflection region; and a scheduler configured to generate auxiliary deflection region data defining an order in which the auxiliary deflection regions contained in the main deflection region are to be irradiated with the electron beam, the method including the steps of: arranging the main deflection regions, assuming that the positions of the column cells are as designed; creating a joined main deflection region by joining each of the main deflection regions to an adjacent main deflection region; obtaining a corrected main deflection region by correcting the position of each of the main deflection regions based on the actual positions of the column cells; and generating the auxiliary deflection region data by collecting the auxiliary deflection regions contained in an overlapping portion of the corrected main deflection region and the joined main deflection region.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of a configuration of an electron beam exposure apparatus;

FIG. 2 is a plan view illustrating regions on a wafer to be patterned by column cells of the electron beam exposure apparatus of FIG. 1;

FIG. 3 is a block diagram of the column cell of the electron beam exposure apparatus of FIG. 1;

FIG. 4 is a view for explaining the exposure operation of the electron beam exposure apparatus of FIG. 1;

FIG. 5 is a view illustrating a structure of whole exposure data of the electron beam exposure apparatus of FIG. 1;

FIG. 6 is a table illustrating an example of shot data;

FIG. 7 is a block diagram of a scheduler of the electron beam exposure apparatus of FIG. 1;

FIG. 8 is a flowchart for explaining operation of a static unit in a method for generating individual exposure data, which has heretofore been the inventors' practice;

FIG. 9 is an illustration of an example of frames formed by the static unit performing the operation of FIG. 8;

FIG. 10 is an illustration of an example of auxiliary deflection region data generated by processing of FIG. 8;

FIG. 11 is a flowchart for explaining operation of a dynamic unit in the method for generating the individual exposure data, which has heretofore been the inventors' practice;

FIG. 12 is an illustration of main deflection regions arranged based on design data, and corrected main deflection regions arranged based on the actual position of the column cell;

FIG. 13 is an illustration for explaining a method for extracting auxiliary deflection regions lying within the corrected main deflection region;

FIGS. 14A to 14C are illustrations for explaining a method for rearranging the auxiliary deflection regions in the auxiliary deflection region data generated by the method of FIG. 13;

FIG. 15 is a flowchart for explaining operation of the static unit in a method for generating individual exposure data according to a first embodiment;

FIG. 16 is an illustration for explaining a method for creating a joined main deflection region according to the first embodiment;

FIGS. 17A and 17B are illustrations for explaining how to rearrange the auxiliary deflection regions in joined auxiliary deflection region data of FIG. 16;

FIG. 18 is a flowchart for explaining operation of the dynamic unit in the method for generating individual exposure data according to the first embodiment;

FIG. 19 is an illustration of the joined main deflection regions and the corrected main deflection regions;

FIG. 20 is an illustration for explaining a method for generating the auxiliary deflection region data corresponding to the corrected main deflection region according to the first embodiment;

FIG. 21 is an illustration of a method for creating a joined main deflection region according to Modification 1 of the first embodiment;

FIG. 22 is an illustration of a method for creating a joined main deflection region according to Modification 2 of the first embodiment;

FIG. 23 is an illustration of a joined frame according to a second embodiment;

FIG. 24 is an illustration for explaining a method for generating auxiliary deflection region data in the second embodiment;

FIG. 25 is a block diagram of a buffer memory; and

FIG. 26 is a block diagram of an example in which each of the column cells is provided with the scheduler.

### DESCRIPTION OF EMBODIMENTS

Prior to description of embodiments of the present invention, description will be given below with regard to a method for generating exposure data for each of column cells, which has heretofore been the inventors' practice.

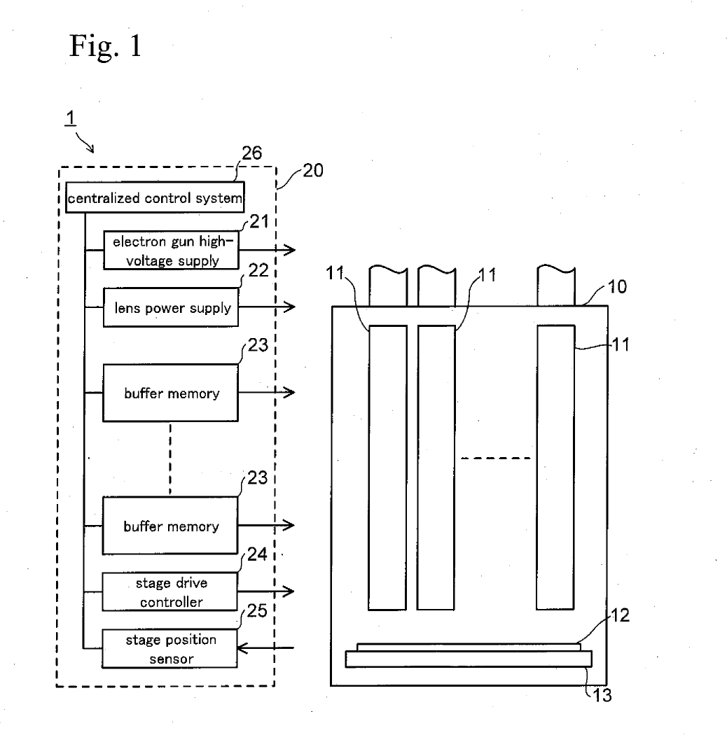

FIG. 1 is a block diagram of an electron beam exposure apparatus.

As illustrated in FIG. 1, an electron beam exposure apparatus 1 is broadly divided into an electron beam column 10 including plural column cells 11, and a controller 20 which controls the electron beam column 10. Of these, the controller 20 includes an electron gun high-voltage power supply 21, a lens power supply 22, buffer memories 23, a stage drive controller 24, and a stage position sensor 25.

The electron gun high-voltage power supply 21 generates a high voltage to drive electron guns of the column cells 11 in the electron beam column 10. The lens power supply 22 supplies a drive current to electromagnetic lenses in the column cells 11 of the electron beam column 10. A corresponding number of the buffer memories 23 is provided for the number of the column cells 11. The buffer memories 23 store individual exposure data as control data for each of the column cells 11, originating from a centralized control system 26. Then, exposure conditions for shots are read out and transferred to the column cells 11, following the order of the individual exposure data. The stage. drive controller 24 moves a wafer 12, based on position information from the stage position sensor 25.

The units 21 to 24 of the controller 20, as described above, are controlled by the centralized control system 26 constructed of a workstation or the like. Also, the centralized control system 26 generates the individual exposure data for control of exposure operation of each of the column cells 11, based on input design data.

Meanwhile, the electron beam column 10 includes the plural, e.g. eight, same column cells 11. Also, a wafer stage 13 mounting the wafer 12 is arranged below the column cells 11.

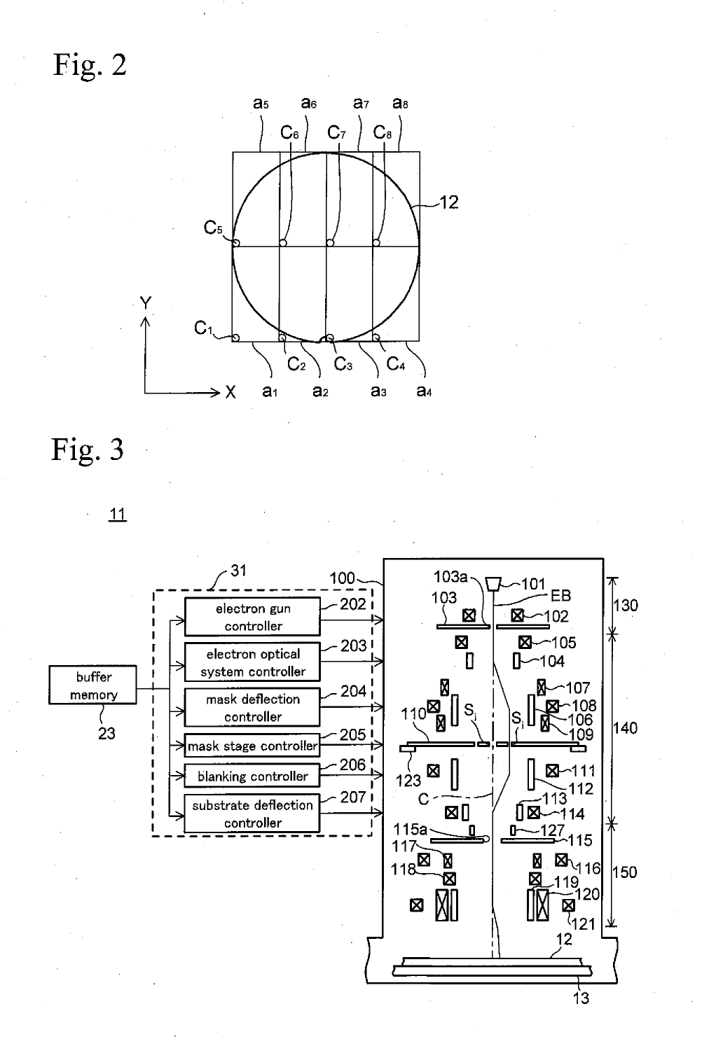

FIG. 2 is a plan view illustrating regions on the wafer 12 to be subjected to patterning by the column cells 11. As illustrated in FIG. 2, the column cells 11 are arranged at positions indicated by the reference characters C₁ to C₈, respectively, to perform exposures of rectangular regions a₁ to a₈, respectively.

FIG. 3 is a block diagram of the column cell 11 of the electron beam exposure apparatus 1 illustrated in FIG. 1.

As illustrated in FIG. 3, the column cell 11 is broadly divided into an exposure unit 100, and a column cell controller 31 which controls the exposure unit 100. Of these, the exposure unit 100 includes an electron beam generator 130, a mask deflector 140, and a substrate deflector 150.

In the electron beam generator 130, electrons 20. emitted from an electron gun 101 are focused through a first electromagnetic lens 102 into an electron beam EB having a predetermined current density. The electron beam EB is shaped through a rectangular aperture 103a of a beam shaping mask 103 into a rectangular shape in cross section.

After that, the electron beam EB is subjected to the converging action of a second electromagnetic lens 105 of the mask deflector 140, and is then deflected by a first electrostatic deflector 104 and a second electrostatic deflector 106 thereby to form an image of a predetermined pattern Sᵢ of an exposure mask 110. A third electromagnetic lens 108 and a fourth electromagnetic lens 111 arranged above and below the exposure mask 110, respectively, serve the function of focusing the electron beam EB into an image on the wafer.

The electron beam EB is shaped through the exposure mask 110 into the shape of the pattern Sᵢ in cross section. Incidentally, to use a portion of the pattern Sᵢ beyond a deflection range (or a beam deflection range) of the first electrostatic deflector 104 and the second electrostatic deflector 106, a mask stage 123 is driven to move the exposure mask 110.

The electron beam EB which has passed through the exposure mask 110 is deflected back to an optical axis C by a third electrostatic deflector 112 and a fourth electrostatic deflector 113, and is then reduced in size by a fifth electromagnetic lens 114. Deflection aberrations in the electron beam EB produced by the electrostatic deflectors 104, 106, 112, 113 of the mask deflector 140 are corrected for by a first shim coil 107 and a second shim coil 109.

After that, the electron beam EB passes through a circular opening (or aperture) 115a of a masking shield 115 of the substrate deflector 150, and is deflected to a predetermined position on the wafer 12 by a fifth electrostatic deflector (or an auxiliary deflector) 119 and an electromagnetic deflector (or a main deflector) 120. The main deflector 120 provides a relatively wide range of electron beam deflection, while the auxiliary deflector 119 provides a smaller range and higher speed of electron beam deflection, as compared to the main deflector 120. Deflection aberrations, in the electron beam EB produced by the deflectors 119, 120 are corrected for by a third shim coil 117 and a fourth shim coil 118. Also, a first projection electromagnetic lens 116 and a second projection electromagnetic lens 121 serve the function of focusing the electron beam EB into an image on the surface of the wafer 12.

Meanwhile, the column cell controller 31 includes an electron gun controller 202, an electron optical system controller 203, a mask deflection controller 204, a mask stage controller 205, a blanking controller 206, and a substrate deflection controller 207. Of these, the electron gun controller 202 controls the electron gun 101 thereby to control beam emission conditions such as an accelerating voltage of the electron beam EB. Also, the electron optical system controller 203 controls the amount of current supplied to the electromagnetic lenses 102, 105, 108, 111, 114, 116, 121 thereby to adjust the magnification or focal point of an electron optical system. The mask deflection controller 204 controls a voltage applied to the first electrostatic deflector 104 and the second electrostatic deflector 106 thereby to guide the electron beam EB to the desired pattern Sᵢ on the exposure mask 110.

The blanking controller 206 controls a voltage applied to a blanking electrode 127 thereby to allow the passage of the electron beam EB through the aperture 115a of the masking shield 115 for a predetermined period of exposure period (or shot time) and thereby control a period of time for irradiation of the surface of the wafer 12 with the electron beam EB. The substrate deflection controller 207 controls a voltage applied to the fifth electrostatic deflector (or the auxiliary deflector) 119 and the amount of current supplied to the electromagnetic deflector (or the main deflector) 120 thereby to deflect the electron beam EB to a desired position on the wafer 12.

The units 202 to 207 of the column cell controller 31 operate based on individual exposure data originating from the centralized control system 26.

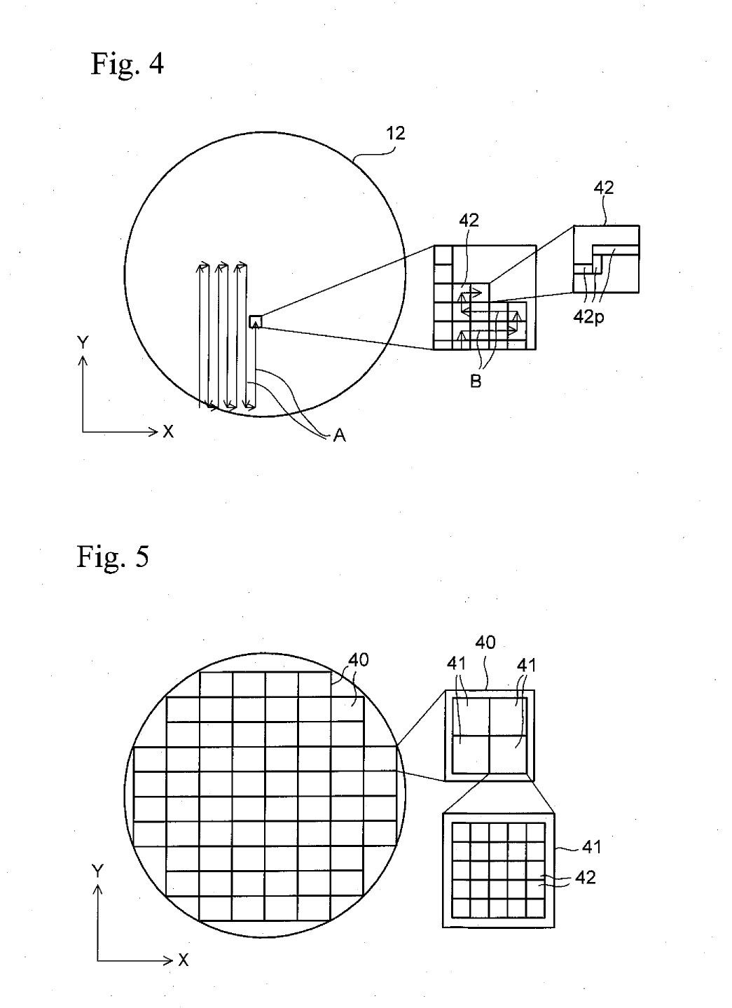

Next, description will be given with regard to exposure operation of the above-described electron beam exposure apparatus 1. Here, FIG. 4 is a view for explaining the exposure operation of the electron beam exposure apparatus 1.

The electron beam exposure apparatus 1 performs exposure of the wafer 12, while continuously moving the wafer 12 by the stage 13 in the Y direction as indicated by the arrows A of FIG. 4. The main deflector 120 of each of the column cells 11 irradiates auxiliary deflection regions 42 with the electron beam, while sequentially shifting the deflection position of the electron beam in a row direction (or in the X direction) and in a column direction (or in the Y direction) as indicated by the arrows B.

While the position of deflection by the main deflector 120 is in a predetermined one of the auxiliary deflection regions 42, deflection of the electron beam EB by the auxiliary deflector 119 takes place to perform shots of exposure in the predetermined auxiliary deflection region 42. Thereby, a pattern 42p is traced in the auxiliary deflection region 42. Upon completion of all shots in one of the auxiliary deflection regions 42, the main deflector 120 shifts the deflection position of the electron beam to the next auxiliary deflection region.

In this manner, the column cells 11 make repeated exposures of strips of regions (or frames) extending in the direction of continuous movement (or the to-and-fro movement direction) of the stage 13.

The above-described exposure operation is performed based on exposure data given below. Here, FIG. 5 is a view illustrating a structure of whole exposure data containing exposure data for all column cells.

As illustrated in FIG. 5, the whole exposure data contains BEFs (Block Exposure Files) 40 as exposure data for each chip, and layout data which defines a layout of the BEFs 40 on the wafer 12. As illustrated in an enlarged partial view of FIG. 5, each of the BEFs 40 contains plural main deflection regions 41, each of which contains plural auxiliary deflection regions 42. Incidentally, the main deflection regions 41 correspond to the regions where the electron beam EB is deflectable with the main deflector 120, while the auxiliary deflection regions 42 correspond to the regions where the electron beam EB is deflectable with the auxiliary deflector 119.

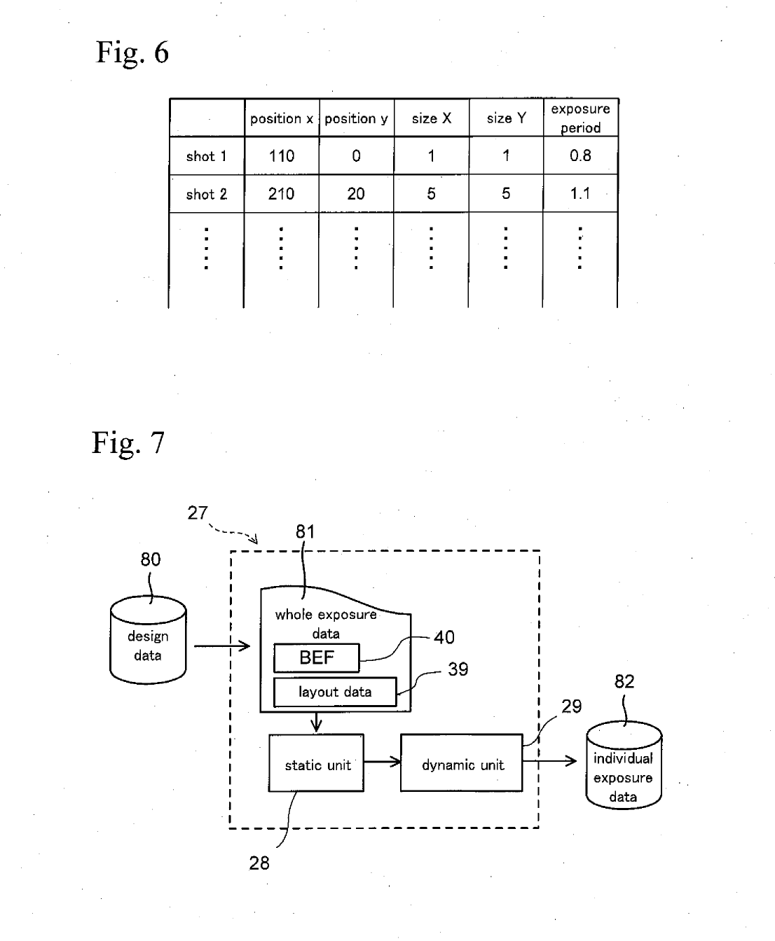

Further, shot data for each of the auxiliary deflection regions 42 is illustrated in FIG. 6. As illustrated in FIG. 6, the shot data contains conditions for shots, including the deflection position of the beam (x, y), the size of the beam (or the pattern shape of the beam), and the exposure period, which are arranged in the order of the shots.

Next, description will be given with regard to a method for generating the individual exposure data for control of the exposure operation of each of the column cells 11.

FIG. 7 is a block diagram of a scheduler 27 provided in the centralized control system 26.

As illustrated in FIG. 7, the scheduler 27 generates whole exposure data 81 containing the BEFs 40 and layout data 39 indicating the layout of the BEFs 40, based on input design data 80. Then, the whole exposure data 81 is converted into individual exposure data 82 by a static unit 28 and a dynamic unit 29.

Description will be given below with regard to the method for generating the individual exposure data, which has heretofore been the inventors' practice, and problems inherent therein.

(Method for Generating Individual Exposure Data, which has Heretofore been the Inventors' Practice)

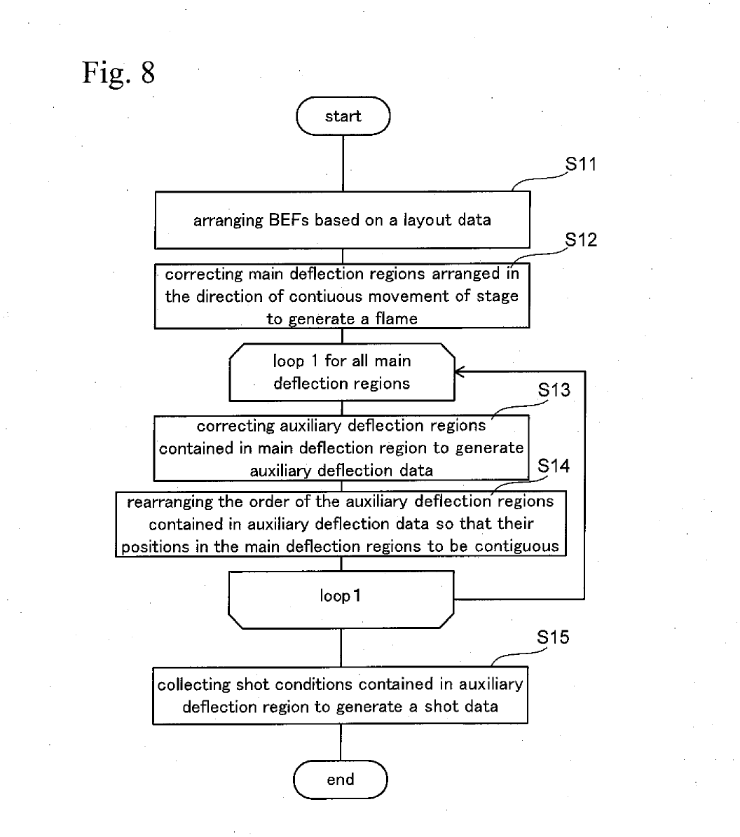

FIG. 8 is a flowchart for explaining operation of the static unit 28 in the method for generating the individual exposure data, which has heretofore been the inventors' practice.

At step S11 of FIG. 8, the static unit 28 arranges the BEFs 40 in regions to be subjected to exposure by each of the column cells 11, based on the input BEFs 40 and layout data. Here, the static unit 28 determines the coordinates of the positions of the BEFs 40, assuming that the positions of the column cells 11 are as designed.

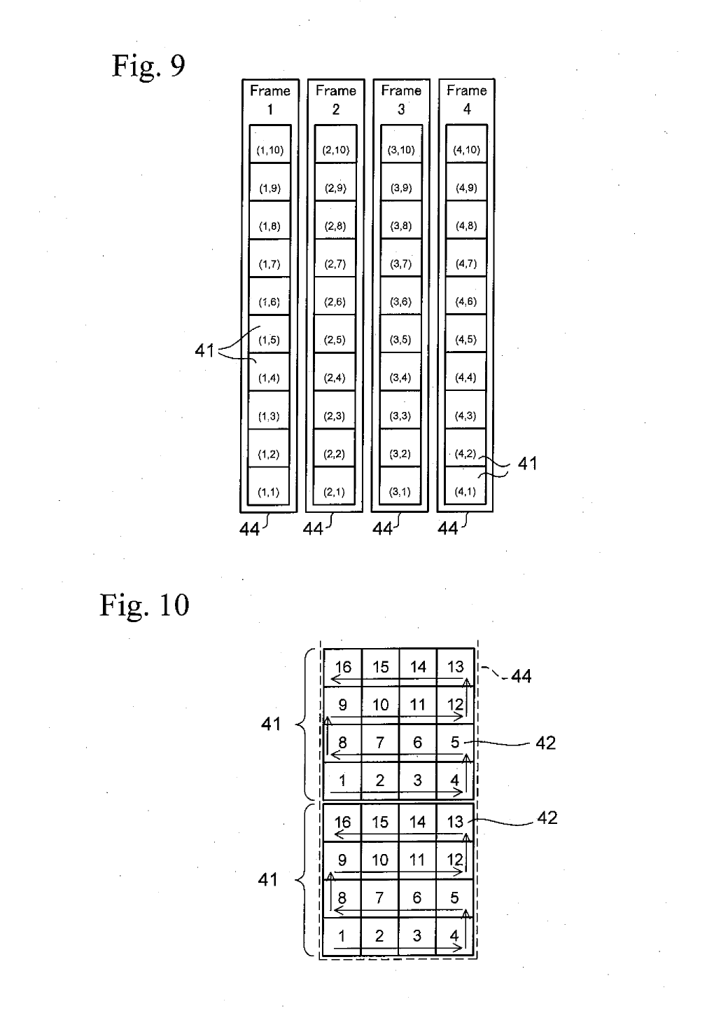

Then, at step S12, the static unit 28 collects plural main deflection regions 41 arranged in the direction of continuous movement of the stage 13 (or in the Y direction) from plural BEFs 40 into frames. Each column cell 11 makes exposures across plural frames. In this manner, the whole exposure data is divided into exposure data for each of the column cells 11 on a frame basis. By step S12, frames 44 are formed as illustrated for example in FIG. 9.

Then, at step S13 (see FIG. 8), the static unit 28 generates auxiliary deflection region data formed of a collection of data for the auxiliary deflection regions 42 contained in each of the main deflection regions 41. The order of the auxiliary deflection regions 42 in the auxiliary deflection region data defines the order in which the auxiliary deflection regions 42 in each of the main deflection regions 41 are to be irradiated with the electron beam EB deflected by the main deflector 120. In other words, the auxiliary deflection region data serves as control data for control of operation of the main deflector 120. The auxiliary deflection region data, one each, is created for each of the main deflection regions 41.

Then, at step S14, the order of the auxiliary deflection regions 42 contained in the auxiliary deflection region data is changed so that their positions in the main deflection region 41 are contiguous.

FIG. 10 is an illustration of an example of the auxiliary deflection region data generated by steps S13 and S14 of FIG. 8. Incidentally, in FIG. 10, numbers assigned to the auxiliary deflection regions 42 represent the order of the auxiliary deflection regions 42 in the auxiliary deflection region data.

An arrangement as illustrated in FIG. 10 enables an efficient shift of the position of irradiation with the electron beam EB by the main deflector 120.

After that, the above steps S13 and S14 (see FIG. 8) are executed for all main deflection regions 41 contained in the regions to be subjected to exposure by each of the column cells 11 (in a loop 1). Upon completion of execution of steps S13 and S14 for all main deflection regions 41, the operation goes to step S15.

At the next step S15, the static unit 28 collects shot conditions for shots to be performed in the auxiliary deflection regions 42 into shot data, and the operation of the static unit 28 is brought to an end.

In the manner as above described, the static unit 28 generates the frames, the auxiliary deflection region data, and the shot data.

However, the exposure data generated by the static unit 28 cannot be utilized as it is, because of being obtained on the assumption that the column cells 11 are in their designed positions. In other words, a housing of the electron beam exposure apparatus 1 becomes deformed due to variations in atmospheric pressure or temperature, and the positions of the column cells 11 vary with time. Therefore, when the exposure data generated by the static unit 28 is used as it is for the column cells 11 to perform exposures, the exposure positions become misaligned.

Therefore, the dynamic unit 29 of the scheduler 27 reedits the exposure data generated by the static unit 28, for adaptation to the actual positions of the column cells.

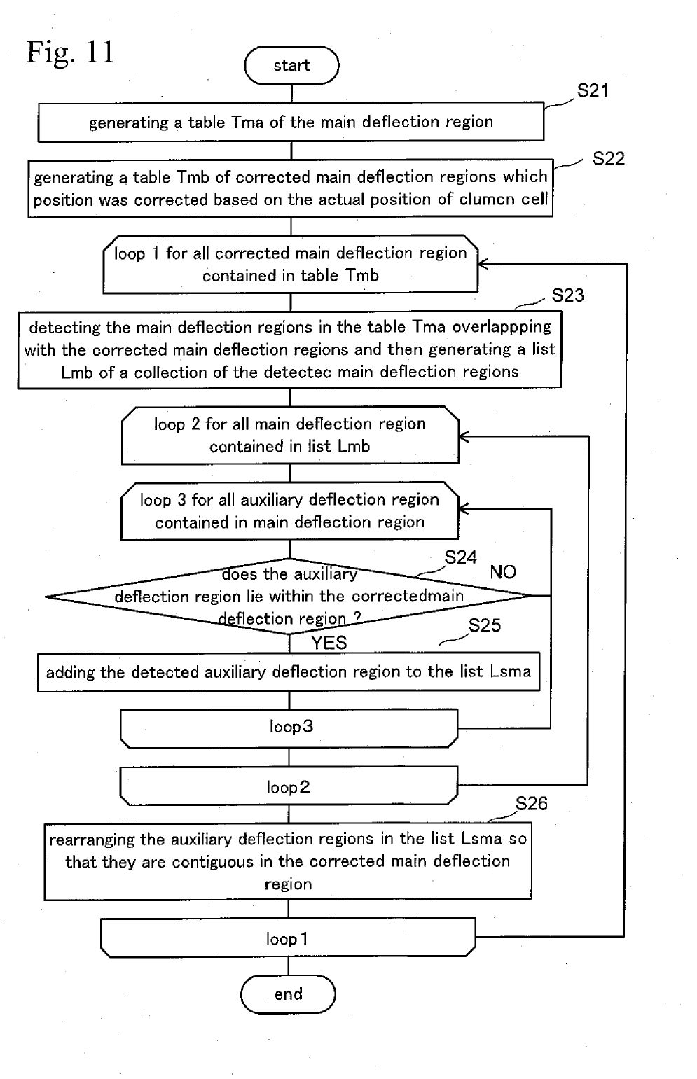

FIG. 11 is a flowchart for explaining operation of the dynamic unit 29 in the method for generating the individual exposure data, which has heretofore been the inventors' practice.

First, at step S21 of FIG. 11, the dynamic unit 29 generates a table Tma of the main deflection regions 41 contained in all BEFs 40 arranged by the static unit 28.

At the next step S22, the dynamic unit 29 arranges corrected main deflection regions 51 corrected for their positions, based on the actual position of the column cell 11, and generates a table Tmb of the corrected main deflection regions 51.

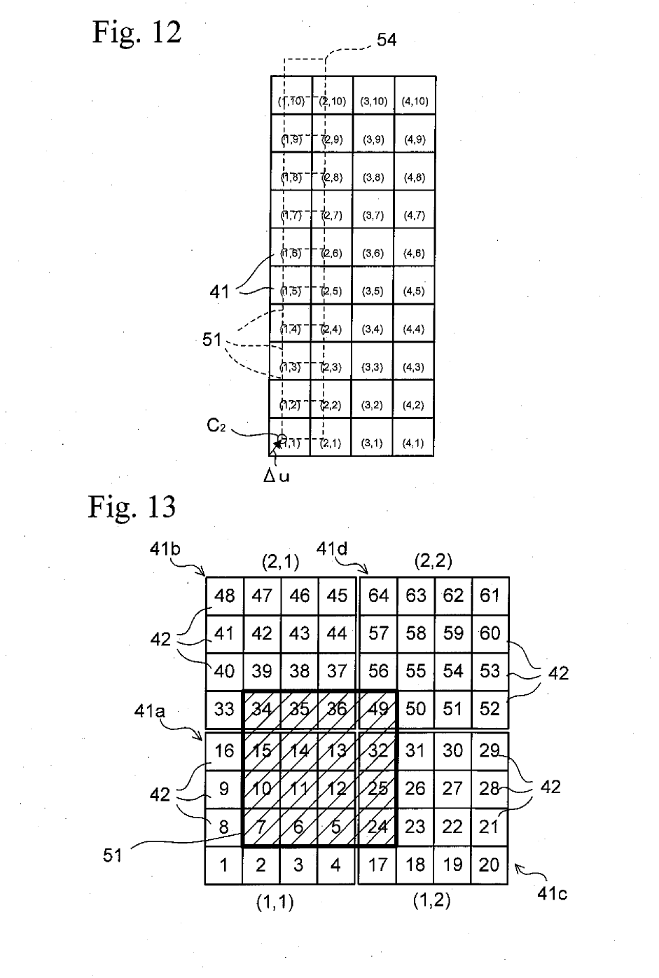

FIG. 12 is an illustration illustrating the corrected main deflection regions 51 arranged by the dynamic unit 29, and the main deflection regions 41 arranged by the static unit 28. As illustrated in FIG. 12, the corrected main deflection regions 51 are arranged in positions offset from the main deflection regions 41 by the amount of misalignment Δu of the position C₂ of the column cell 11. Incidentally, in FIG. 12, the corrected main deflection regions 51 are illustrated only as a frame (e.g. a frame 54) of the corrected main deflection regions 51; however, in step S22, the corrected main deflection regions 51 are arranged in such a way as to cover all main deflection regions 41.

Then, at step S23 (see FIG. 11), the dynamic unit 29 detects the main deflection regions 41 in the table Tma overlapping with the corrected main deflection regions 51, and generates a list Lmb of a collection of the detected main deflection regions 41.

FIG. 13 is an illustration for explaining a method for extracting the regions overlapping with the corrected main deflection region 51. In the case of FIG. 13, the table Tma (see FIG. 12) is searched for the main deflection regions 41 overlapping with the corrected main deflection region 51. Then, the list Lmb made up of main deflection regions 41a, 41b, 41c, 41d overlapping with the corrected main deflection region 51 is generated.

Then, the operation goes to step S24 (see FIG. 11), where the dynamic unit 29 determines whether or not the auxiliary deflection regions 42 of the main deflection regions 41 contained in the list Lmb lie within the corrected main deflection region 51. In step S24, when a decision is made that the auxiliary deflection regions 42 lie within the corrected main deflection region 51 (“Yes”), the operation goes to step S25, where the detected auxiliary deflection regions 42 are added to a list Lsma. Meanwhile, in step S24, when a decision is made that the auxiliary deflection regions 42 do not lie within the corrected main deflection region 51 (“No”), the auxiliary deflection regions 42 are not added to the list Lsma.

After that, steps S24 and S25 are repeatedly executed for all auxiliary deflection regions 42 contained in the main deflection regions 41 (in a loop 3). Also, the loop 3 is repeated for all main deflection regions 41 contained in the list Lmb (in a loop 2).

The list Lsma of a collection of data for the auxiliary deflection regions 42 lying within the corrected main deflection region 51 illustrated in FIG. 13 (or the auxiliary deflection region data) is completed by the above loop 3 and loop 2.

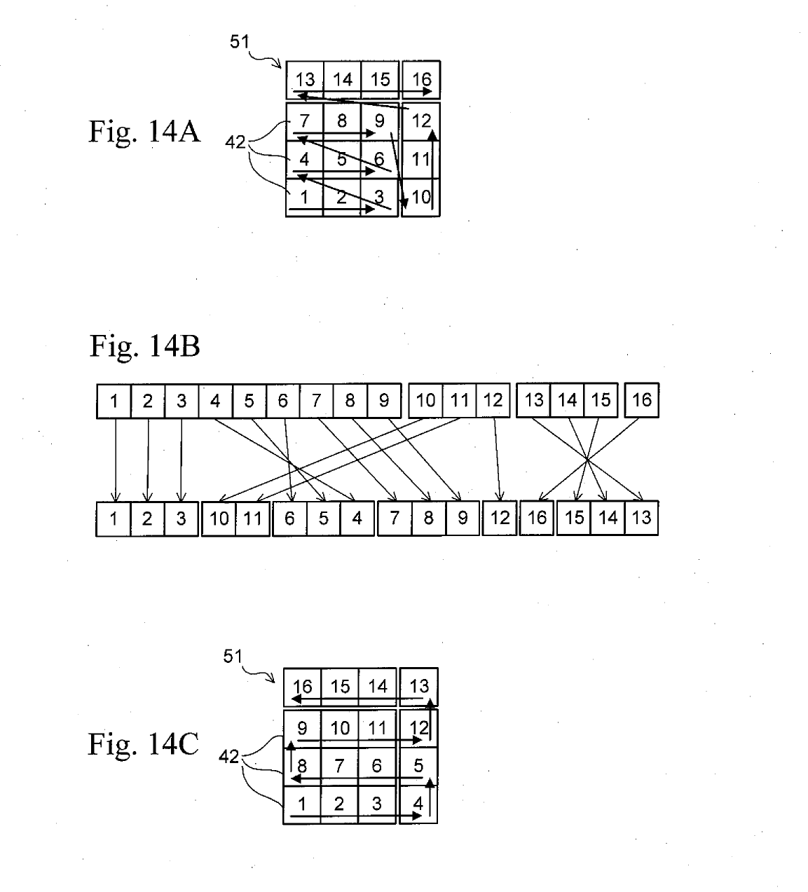

FIG. 14A illustrates the order of the auxiliary deflection regions contained in the list Lsma before rearrangement. As illustrated in FIG. 14A, the auxiliary deflection regions 42 are arranged in the list Lsma in the order in which they are detected by the loop 2 and the loop 3. Therefore, when the list Lsma is used as it is as the auxiliary deflection region data for the corrected main deflection region 51, the amount of movement of the electron beam EB by the main deflector 120 (or a jump vector) becomes large as indicated by the arrows, which in turn leads to generation of a waiting time for deflection setting and hence to inefficient movement of the electron beam EB.

Therefore, the operation goes to step S26 (see FIG. 11), where the dynamic unit 29 rearranges the auxiliary deflection regions 42 in the list Lsma so that they are contiguous in the corrected main deflection region 51

FIGS. 14B and 14C are illustrations for explaining how to change the order of the auxiliary deflection regions 42 in the list Lsma illustrated in FIG. 14A. The auxiliary deflection regions 42 in the list Lsma before rearrangement are arranged as illustrated in the upper section of FIG. 14B. In step S26, the coordinates of the positions of the auxiliary deflection regions 42 in the list Lsma are detected, and the auxiliary deflection regions 42 are rearranged as illustrated in the lower section of FIG. 14B, based on the detected coordinates of the positions. As a result, as illustrated in FIG. 14C, the auxiliary deflection regions 42 are arranged in a contiguous sequence, shifting to and fro in the row direction and row by row in the column direction in the corrected main deflection region 51. Thereby, the auxiliary deflection region data corresponding to the corrected main deflection region 51 is completed.

After that, steps S23 to S26 are repeatedly executed for all corrected main deflection regions 51 contained in the table Tmb (in the loop 1) thereby to generate the auxiliary deflection region data for each of the corrected main deflection regions 51, and the operation of the dynamic unit 29 comes to completion.

In the manner as above described, the individual exposure data containing the corrected main deflection regions 51 set according to the actual position of the column cell 11 and the auxiliary deflection region data therefor is obtained.

Incidentally, in the above description, the BEFs (or chips) 40 are described as each containing four main deflection regions in order to simplify an understanding; however, generally, more main deflection regions are contained.

For example, when the main deflection region has dimensions on the order of about 100 μm square while each chip has a size of 33 mm×26 mm, the number of main deflection regions 41 contained in each BEF is on the order of 85800 (=330×260). In this case, if it is assumed that each column cell 11 performs exposures on 10 BEFs 40 (=5 rows×2 columns), the dynamic unit 29 generates 858000 (=10×85800) corrected main deflection regions 51 and auxiliary deflection region data therefor, for generation of individual exposure data for each column cell. Therefore, the execution of the loop 1 of FIG. 11 is repeated 858000 times.

Also, in the example illustrated in the drawings, the number of auxiliary deflection regions 42 contained in the main deflection region 41 is illustrated as being 16 for sake of simplicity; however, actually, more, e.g. about 100, auxiliary deflection regions 42 are contained in the main deflection region 41. Therefore, the rearrangement of the auxiliary deflection regions 42 by the dynamic unit 29 as illustrated in FIG. 14B also becomes more complicated.

Further, when the above-described processing is performed for the number of column cells 11, e.g. for eight Column cells 11, the method for generating the individual exposure data, which has heretofore been the inventors' practice, has the problem of being incapable of quick generation of the individual exposure data because of requiring about 10 hours for the generation of the individual exposure data.

In view of the foregoing problems, the inventors have designed a method for generating individual exposure data according to a first embodiment of the present invention to be described below.

### First Embodiment

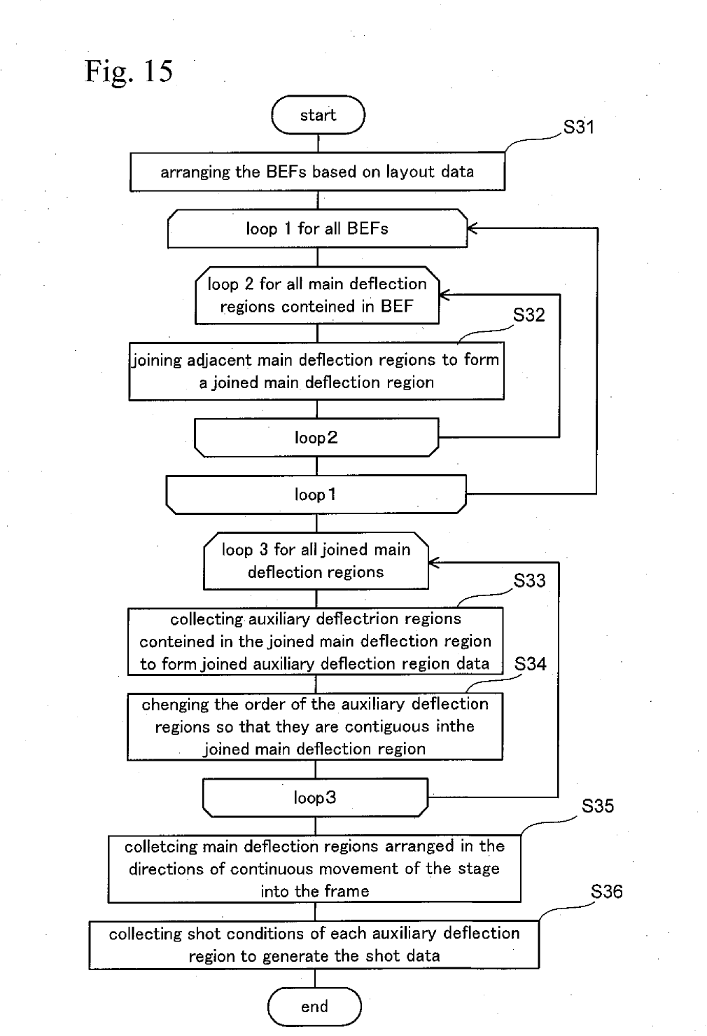

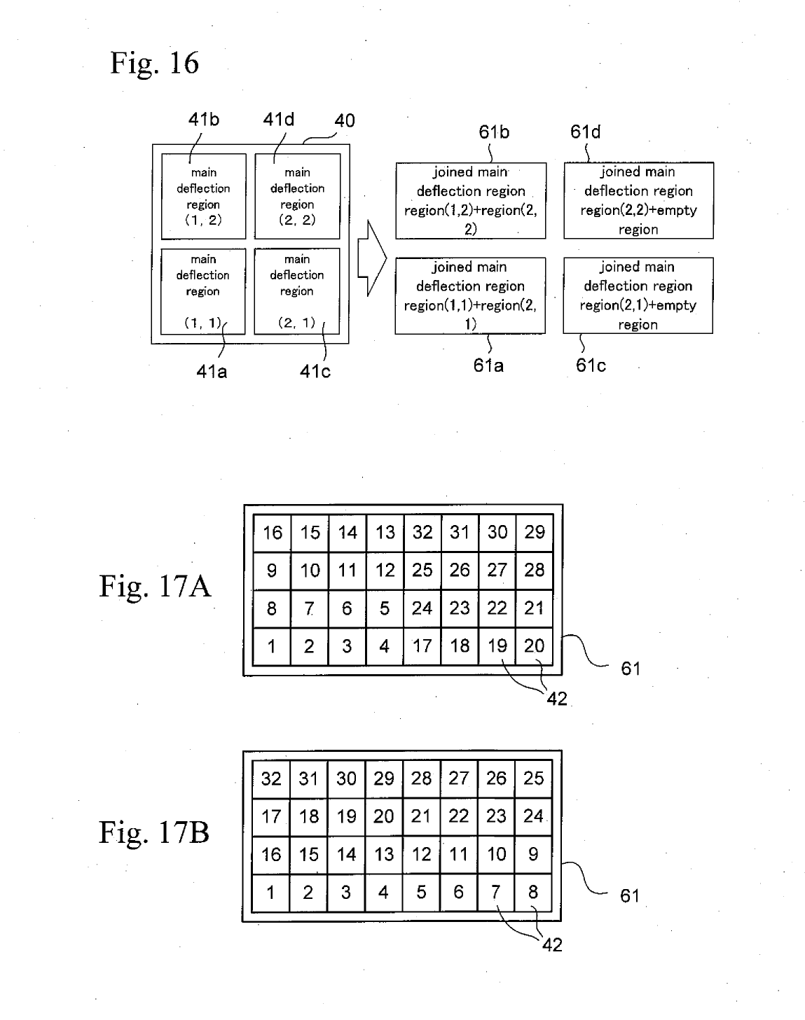

FIG. 15 is a flowchart for explaining operation of the static unit 28 in the method for generating individual exposure data according to the first embodiment. FIG. 16 is an illustration for explaining a method for creating a joined main deflection region.

In the first embodiment, first, at step S31 of FIG. 15, the static unit 28 arranges the BEFs 40 based on layout data. Here, the coordinates of the positions of the BEFs 40 are determined, assuming that the positions of the column cells 11 are as designed.

Then, the operation goes to step S32, where the static unit 28 joins adjacent ones of the main deflection regions 41a to 41d in the BEF 40 thereby to create joined main deflection regions 61. For example, when the position of the column cell 11 is misaligned in a rightward direction relative to the designed position, the main deflection region 41a at the lower left of the BEF 40 illustrated in FIG. 16 is joined to the main deflection region 41c on the right side of the main deflection region 41a thereby to form a joined main deflection region 61a. Also, when an adjacent main deflection region on the right is absent as in the case of, for example, the main deflection region 41c at the lower right of the BEF 40, an empty region containing no exposure data is created, and the empty region is joined to the main deflection region 41c from the right side thereof thereby to form a joined main deflection region 61c.

Meanwhile, when the position of the column cell 11 is misaligned in a leftward direction, each of the main deflection regions may be joined to an adjacent main deflection region on the left.

As described above, main deflection regions adjacent to each other in a direction of misalignment of the position of the column cell 11 are joined together, and thereby, when at a later step a corrected main deflection region is set based on the actual position of the column cell 11, the corrected main deflection region overlaps with the joined main deflection regions to thus facilitate extraction of the auxiliary deflection regions 42.

Step S32 is repeatedly executed for all main deflection regions 41 in the BEF 40 (in a loop 2). Thereby, as illustrated in FIG. 16, the joined main deflection regions 61a to 61d are created for the main deflection regions 41a to 41d, respectively.

After that, the loop 2 (see FIG. 15) is repeatedly executed for the main deflection regions contained in all BEFs 40 (in a loop 1). Thereby, the joined main deflection regions 61a to 61d are created for the main deflection regions 41a to 41d, respectively.

Then, the operation goes to step S33, where the static unit 28 collects data for the auxiliary deflection regions 42 contained in the joined main deflection region 61 into joined auxiliary deflection region data.

Then, at step S34, the static unit 28 changes the order of the auxiliary deflection regions 42 in the joined auxiliary deflection region data so that they are contiguous in the joined main deflection region 61a.

FIGS. 17A and 17B are illustrations for explaining how to rearrange the auxiliary deflection regions 42 in the joined auxiliary deflection region data in the first embodiment. The auxiliary deflection regions 42 in the joined auxiliary deflection region data generated by step S33 are in noncontiguous arrangement in the joined main deflection region 61, as illustrated in FIG. 17A. Therefore, in step S34, the auxiliary deflection regions 42 in the joined auxiliary deflection region data are rearranged in a contiguous sequence, shifting to and fro in the row direction and row by row in the column direction in the joined main deflection region 61, as illustrated in FIG. 17B.

Steps S33 and S34 are repeated for all joined main deflection regions (in a loop 3) thereby to generate joined auxiliary deflection region data for each of the joined main deflection regions.

After that, the operation goes to step S35, where the static unit 28 collects plural main deflection regions 41 arranged in the direction of continuous movement of the stage 13 (or in the Y direction) into the frames 44.

Then, shot data 46 formed of a collection of shot conditions is generated for each of the auxiliary deflection regions 42, and the operation of the static unit 28 is brought to an end.

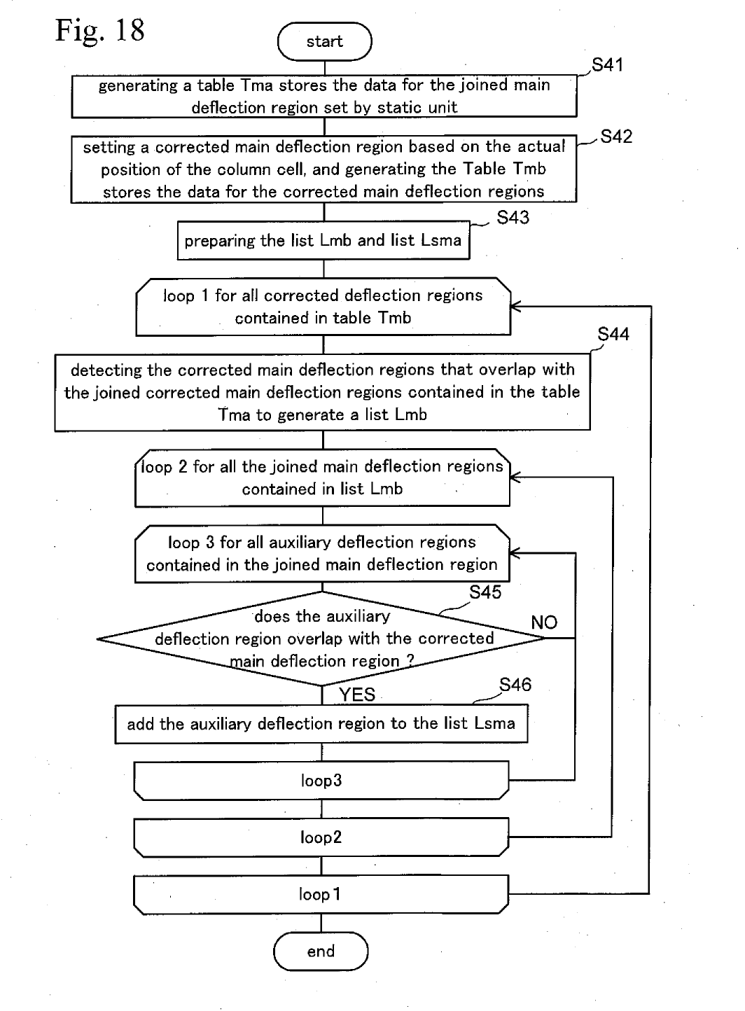

Next, the dynamic unit 29 performs reediting of the exposure data. Here, FIG. 18 is a flowchart for explaining operation of the dynamic unit 29 in the method for generating individual exposure data according to the first embodiment.

First, at step S41, the dynamic unit 29 generates the table Tma storing data for the joined main deflection regions set by the static unit 28. Then, at step S42, corrected main deflection regions are set based on the actual position of the column cell 11, and the table Tmb storing data for the corrected main deflection regions is generated.

Then, at step S43, the dynamic unit 29 prepares the list Lmb for listing of the joined main deflection regions overlapping with the corrected main deflection regions, and the list Lsma for listing of the auxiliary deflection regions 42 overlapping with the corrected main deflection regions.

Then, at step S44, any one of the corrected main deflection regions contained in the table Tma is selected, the joined main deflection regions overlapping with the selected corrected main deflection region are detected, and the detected joined main deflection regions are stored in the list Lmb. Step S44 is repeated for all main deflection regions contained in the table Tma (in a loop 1).

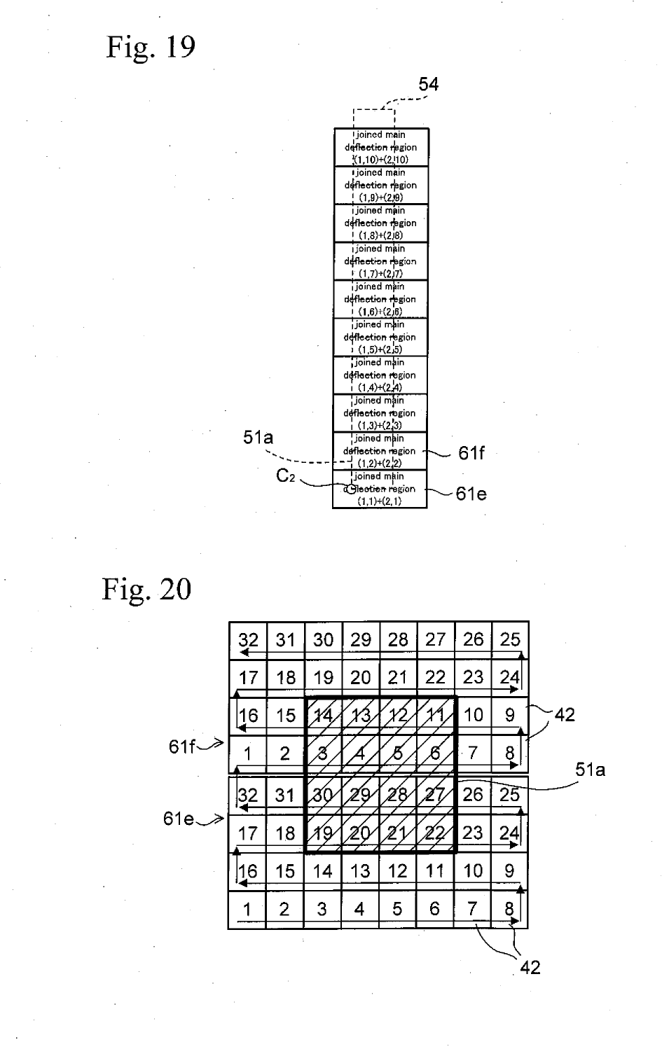

FIG. 19 illustrates joined main deflection regions (illustrated in full-line rectangles) and a corrected main deflection region 51a (illustrated in a broken-line rectangle). Joined main deflection regions 61e, 61f overlap with the corrected main deflection region 51a illustrated in the lowermost part of FIG. 19. Therefore, in step S44, the joined main deflection regions 61e, 61f are stored in the list Lmb corresponding to the corrected main deflection region 51a.

Then, a loop 2 and a loop 3 are executed in which steps S45 and S46 given below are repeatedly executed for the auxiliary deflection regions 42 contained in all joined main deflection regions contained in the list Lmb.

At step S45, the dynamic unit 29 determines whether or not the auxiliary deflection regions 42 in the joined main deflection region 61e overlap with the corrected main deflection region 51a. A decision as to whether or not the auxiliary deflection regions 42 overlap with the corrected main deflection region 51a is made based on the coordinates of the positions of the auxiliary deflection regions 42 and the corrected main deflection region 51a. In step S45, when a decision is made that the auxiliary deflection region 42 overlaps with the corrected main deflection region 51a (“Yes”), the operation goes to step S46, where the auxiliary deflection region 42 is stored in the list Lsma. Also, when a decision is made that the auxiliary deflection region 42 does not overlap with the corrected main deflection region 51a (“No”), the auxiliary deflection region 42 is not stored in the list Lsma.

FIG. 20 is an illustration for explaining the processing of the above steps S45 and S46. First, as illustrated in FIG. 20, a decision is made as to whether or not the auxiliary deflection region 42 at the lower left of the joined main deflection region 61e overlaps with the corrected main deflection region 51a (at step S45). The auxiliary deflection region 42 does not overlap with the corrected main deflection region 51a, and thus, in the loop 3, step S45 is executed for the second auxiliary deflection region 42 on the right of the first auxiliary deflection region 42. In the loop 3, detection of the auxiliary deflection region 42 overlapping with the corrected main deflection region 51a (i.e. steps S45 and S46) is repeated in the order indicated by the arrows of FIG. 20, in the joined main deflection region 61e.

After that, upon completion of the processing on all auxiliary deflection regions 42 in the joined main deflection region 61e, the loop 2 causes the processing to move to the next joined main deflection region 61f. Then, the loop 3 is executed also in the joined main deflection region 61f thereby to perform the detection of the auxiliary deflection region 42 overlapping with the corrected main deflection region 51a (i.e. steps S45 and S46) in the order indicated by the arrows of FIG. 20.

In the manner as above described, a list Lsmb (or auxiliary deflection region data) of a collection of data for the auxiliary deflection regions 42 overlapping with the corrected main deflection region 51a is obtained. The order of the auxiliary deflection regions 42 in the auxiliary deflection region data is such that their positions in the corrected main deflection region 51a are in a contiguous sequence, shifting to and fro in the row direction and row by row in the column direction.

As described above, in the first embodiment, adjacent main deflection regions are joined together to form a joined main deflection region larger than the amount of misalignment of the column cell 11 relative to the designed position. Then, a decision is made as to whether or not each of the auxiliary deflection regions in the joined main deflection region overlaps with the corrected main deflection region, in order such that the auxiliary deflection regions are in a contiguous sequence, shifting to and fro in the row direction and row by row in the column direction.

As described above, the order of the auxiliary deflection regions contained in the joined main deflection region is such that the auxiliary deflection regions are arranged in a contiguous sequence, shifting to and fro in the row direction and row by row in the column direction. Thus, even with the corrected main deflection region in any position, when data for portions corresponding to the corrected main deflection region is extracted from the joined main deflection region, the auxiliary deflection regions in the corrected main deflection region are contiguous as indicated by the arrows.

Therefore, according to the first embodiment, the need to change the order of the auxiliary deflection regions 42 in the auxiliary deflection region data is eliminated, so that quicker generation of individual exposure data can be achieved.

The inventors have carried out generation of individual exposure data in an instance where each chip has a size of 33 mm×26 mm, the main deflection region 41 has dimensions of about 100 μm square, and 100 auxiliary deflection regions are contained in each main deflection region. Here, the length of time taken to generate the individual exposure data was measured under a condition where the number of column cells 11 is eight and each column cell 11 includes 10 chips (or BEFs) (=5 rows×2 columns).

As a result, the static unit 28 took about 90 seconds to finish the processing, and the dynamic unit 29 took about 120 seconds to finish the processing, so that the generation of the individual exposure data could be accomplished in a total of 210 seconds. On the other hand, the method for generating the individual exposure data, which has heretofore been the inventors' practice, required 10 or more hours for the generation of the same individual exposure data.

It is clear from the results that, according to the first embodiment, quick generation of individual exposure data can be achieved.

According to the electron beam exposure apparatus of the above embodiment, the scheduler creates the joined main deflection region by joining adjacent ones of the main deflection regions which are arranged assuming that the positions of the column cells are as designed. Then, the dynamic unit obtains the corrected main deflection region by correcting the position of each of the main deflection regions based on the actual positions of the column cells, and detects the auxiliary deflection regions overlapping with the corrected main deflection region, from the joined main deflection region, in predetermined order. Thereby, the auxiliary deflection region data is obtained in which the auxiliary deflection regions are arranged contiguous in the corrected main deflection region.

This eliminates the need to change the order of the auxiliary deflection regions in the auxiliary deflection region data so that they are contiguous in the corrected main deflection region, thus enabling quicker generation of individual exposure data for each of the column cells.

### (Modification 1)

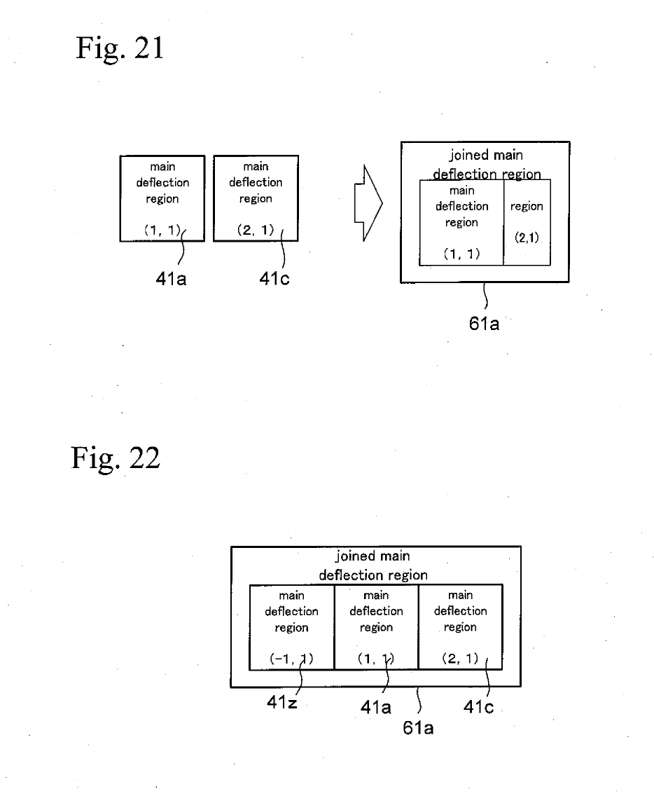

FIG. 21 is an illustration of a method for creating a joined main deflection region according to Modification 1 of the first embodiment.

In the first embodiment, two adjacent main deflection regions are joined together to form a joined main deflection region; however, when the amount of misalignment of the position of the column cell 11 is sufficiently small, the left half of the adjacent main deflection region 41c on the right side of the main deflection region 41a may be joined to the main deflection region 41a thereby to form the joined main deflection region 61a, as illustrated in FIG. 21.

In this case, the joined main deflection region 61a becomes small in data size, thus enabling quicker generation of individual exposure data.

### (Modification 2)

FIG. 22 is an illustration of a method for creating the joined main deflection region 61 according to Modification 2 of the first embodiment.

In Modification 2, as illustrated in FIG. 22, the adjacent main deflection regions 41c, 41z on the right and left sides, respectively, of the main deflection region 41a may be joined to the main deflection region 41a thereby to form the joined main deflection region 61a.

In this case, even when the column cell 11 is misaligned toward the left or the right, a corrected main deflection region 51z arranged based on the actual position of the column cell 11 falls within the range of the joined main deflection region 61a. Thereby, the ability to cope with misalignment of the position of the column cell 11 is enhanced.

Also, the joined main deflection region is not limited to the above-described examples but may be formed for example by joining together four adjacent main deflection regions adjoining each other in the direction of continuous movement of the stage (or in the Y direction) and in a direction orthogonal to the direction of continuous movement of the stage (or in the X direction).

### Second Embodiment

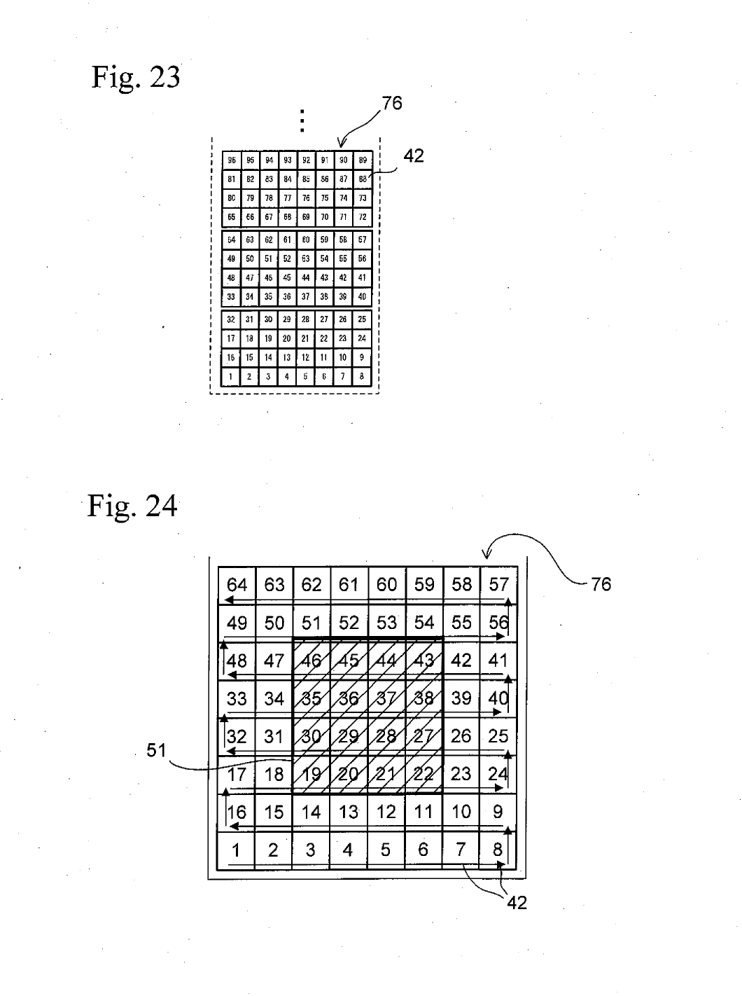

FIG. 23 is an illustration of a joined frame formed in a second embodiment.

The second embodiment is different from the first embodiment in which the auxiliary deflection regions overlapping with the corrected main deflection regions are extracted for each of the joined main deflection regions, in that, as illustrated in FIG. 23, the joined main deflection regions arranged in the direction of continuous movement of the stage 13 are collected into a joined frame 76 (illustrated in a portion enclosed by broken lines), and the auxiliary deflection regions overlapping with the corrected main deflection regions are extracted from the joined frame 76.

In FIG. 23, numbers in rectangles represent the order of the auxiliary deflection regions 42 in the joined frame 76, and a decision is made as to whether or not each of the auxiliary deflection regions 42 lies within the corrected main deflection region, following the order of the auxiliary deflection regions 42. Incidentally, formation of the joined frame 76 is performed by the static unit 28.

FIG. 24 is an illustration of a method for generating auxiliary deflection region data (or the list Lsma) in the second embodiment.

As illustrated in FIG. 24, in the second embodiment, the auxiliary deflection regions 42 of the joined frame 76 are examined in the order indicated by the arrows of FIG. 24, and data for the auxiliary deflection regions 42 overlapping with the corrected main deflection region 51 is collected to create auxiliary deflection region data.

Thereby, the order of the auxiliary deflection regions in the auxiliary deflection region data is such that they are contiguous in the corrected main deflection region 51, as is the case with the first embodiment. Thus, also in the second embodiment, there is no need to change the order of the auxiliary deflection regions 42 in the auxiliary deflection region data.

Also, in the second embodiment, the corrected main deflection region 51 is contained in one joined frame 76, and thus, there is no need to search across plural joined main deflection regions for the auxiliary deflection regions overlapping with the corrected main deflection region, which is required for the first embodiment. Thus, the number of searches of the joined main deflection region is reduced, so that still quicker generation of individual exposure data can be achieved as compared to the first embodiment.

(Method for Transferring Individual Exposure Data during Exposure)

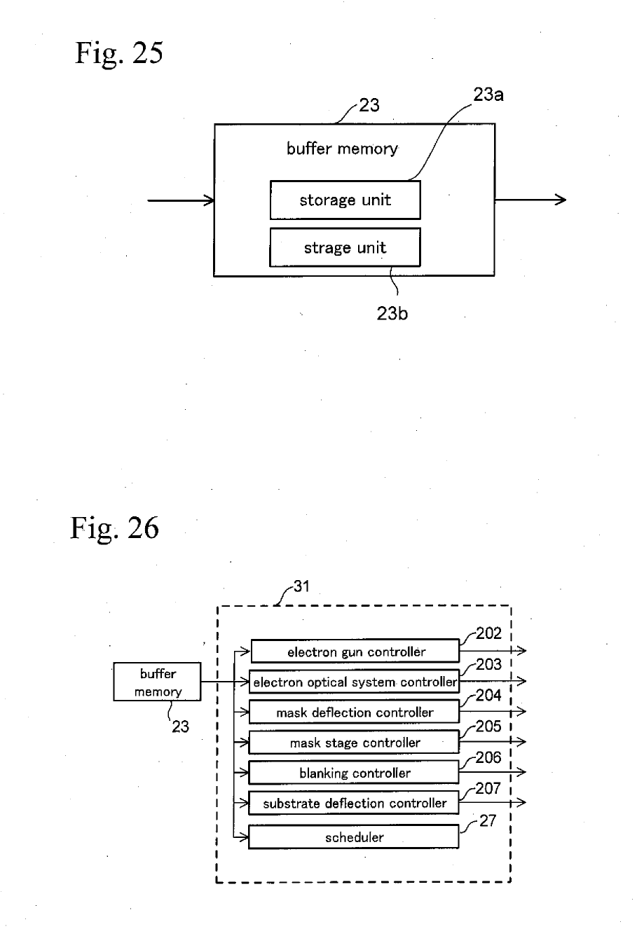

FIG. 25 is a block diagram of the buffer memory 23 of the controller 20.

As illustrated in FIG. 25, the buffer memory 23 may be provided with two storage units 23a, 23b so as to perform parallel processing such that, while one of the storage units, namely, the storage unit 23a, reads out a frame of exposure data in sequence and transfers the exposure data to the column cell controller 31 of the column cell 11, the other, namely, the storage unit 23b, writes the next frame of individual exposure data transferred from the centralized control system 26.

Such operations are performed alternating with each other, thereby enabling continuous transfer of individual exposure data to the column cells 11 and thus achieving quick exposure operation of each of the column cells 11.

### (Method for Generating Individual Exposure Data by Parallel Processing)

FIG. 26 is a block diagram illustrating an example in which each of the column cells 11 is provided with the scheduler 27.

To perform parallel processing for generation of individual exposure data, the column cell controller 31 of each of the column cells 11 is provided with the scheduler 27, as illustrated in FIG. 26.

The centralized control system 26 divides design data for each of regions to be subjected to exposure by each of the column cells 11, and transfers the divided design data to the column cell controller 31 of each of the column cells 11 through the buffer memory 23. Then, the scheduler 27 provided in each of the column cells 11 performs parallel processing for generating individual exposure data. As described above, each of the column cells 11 performs the parallel processing to generate the individual exposure data, thereby enabling quicker generation of the individual exposure data.

1. An electron beam exposure apparatus comprising:
a stage configured to move a sample to and fro in a certain direction;
a plurality of column cells configured to irradiate the sample with an electron beam;
a main deflector provided in each of the column cells, and configured to deflect the electron beam and thereby control the position of irradiation with the electron beam in a main deflection region;
an auxiliary deflector provided in each of the column cells, and configured to deflect the electron beam and thereby control the position of irradiation with the electron beam in an auxiliary deflection region smaller than the main deflection region; and
a scheduler configured to generate auxiliary deflection region data defining an order in which the auxiliary deflection regions in the main deflection region are to be irradiated with the electron beam, the scheduler including
a static unit configured to create a joined main deflection region by joining each of the main deflection regions to an adjacent main deflection region, which are arranged assuming that the positions of the column cells are as designed, and
a dynamic unit configured to obtain a corrected main deflection region by correcting the position of each of the main deflection regions based on the actual positions of the column cells, and to generate the auxiliary deflection region data by collecting data for the auxiliary deflection regions contained in an overlapping portion of the corrected main deflection region and the joined main deflection region.

2. The electron beam exposure apparatus according to claim 1,
wherein the dynamic unit detects whether or not each of the auxiliary deflection regions overlaps with the corrected main deflection region, in an order in which the auxiliary deflection regions are in a contiguous sequence, shifting to and fro in a row direction and row by row in a column direction in the joined main deflection region, and arranges the auxiliary deflection regions in the order of detection thereby to generate the auxiliary deflection region data.

3. The electron beam exposure apparatus according to claim 1,
wherein the static unit joins together main deflection regions adjacent to each other in a direction orthogonal to a to-and-fro movement direction of the stage thereby to form the joined main deflection region.

4. The electron beam exposure apparatus according to claim 3,
wherein the size of the adjacent main deflection region joined to the main deflection region is larger than the amount of misalignment of the actual position of the column cell from the designed position.

5. The electron beam exposure apparatus according to claim 1,
wherein the static unit joins together main deflection regions adjacent to each other in two directions: in the to-and-fro movement direction of the stage and in the direction orthogonal thereto, thereby to form the joined main deflection region.

6. The electron beam exposure apparatus according to claim 1,
wherein the static unit collects a plurality of the joined main deflection regions arranged in the to-and-fro movement direction of the stage thereby to form a joined frame, and
the dynamic unit collects data for the auxiliary deflection regions contained in an overlapping portion of the joined frame and the corrected main deflection region thereby to generate the auxiliary deflection region data.

7. The electron beam exposure apparatus according to claim 1, further comprising:
a buffer memory provided in each of the column cells, and configured to store exposure data contained in a frame formed of a plurality of the main deflection regions arranged in the to-and-fro movement direction of the stage,
wherein the buffer memory concurrently transfers the exposure data to the column cell and stores the exposure data of the next frame transferred from a controller.

8. The electron beam exposure apparatus according to claim 1,
wherein the scheduler is provided in each of the column cells, and
the schedulers generate the exposure data for their respective column cells in parallel.

9. An electron beam exposure method using an electron beam exposure apparatus including: a stage configured to move a sample to and fro in a certain direction; a plurality of column cells configured to irradiate the sample with an electron beam; a main deflector provided in each of the column cells, and configured to deflect the electron beam and thereby control the position of irradiation with the electron beam in a main deflection region; an auxiliary deflector provided in each of the column cells, and configured to deflect the electron beam and thereby control the position of irradiation with the electron beam in an auxiliary deflection region smaller than the main deflection region; and a scheduler configured to generate auxiliary deflection region data defining an order in which the auxiliary deflection regions in the main deflection region are to be irradiated with the electron beam, the method comprising the steps of:
arranging the main deflection regions, assuming that the positions of the column cells are as designed;
creating a joined main deflection region by joining each of the main deflection regions to an adjacent main deflection region;
obtaining a corrected main deflection region by correcting the position of each of the main deflection regions based on the actual positions of the column cells; and
generating the auxiliary deflection region data by collecting the auxiliary deflection regions contained in an overlapping portion of the corrected main deflection region and the joined main deflection region.

10. The electron beam exposure method according to claim 9,
wherein whether or not each of the auxiliary deflection regions overlaps with the corrected main deflection region is detected in an order in which the auxiliary deflection regions are in a contiguous sequence, shifting to and fro in a row direction and row by row in a column direction in the joined main deflection region, and the auxiliary deflection regions are arranged in the order of detection thereby to form the auxiliary deflection region data.

11. The electron beam exposure method according to claim 9,
wherein main deflection regions adjacent to each other in a direction orthogonal to a to-and-fro movement direction of the stage are joined together to form the joined main deflection region.

12. The electron beam exposure method according to claim 11,
wherein the size of the adjacent main deflection region joined to the main deflection region is larger than the amount of misalignment of the actual position of the column cell from the designed position.
